(19) United States
(12) Patent Application Publication
(10) Pub. No.: US 2020/0133386 A1
(43) Pub. Date: Apr. 30, 2020

(54) INPUT SURFACE SYSTEM

(71) Applicant: KOOFY INNOVATION LIMITED, Sheung Wan (CN)

(72) Inventor: Ondy Song Qi Ma, Hong Kong (CN)

(21) Appl. No.: 16/440,920

(22) Filed: Jun. 13, 2019

Related U.S. Application Data
(60) Provisional application No. 62/684,694, filed on Jun. 13, 2018.

(51) Int. Cl. G06F 3/01; A63F 13/214; A63F 13/245

(52) U.S. Cl. CPC G06F 3/011; A63F 2300/8082; A63F 13/245; A63F 13/214

(57) ABSTRACT

An input surface system is provided. The input surface system includes a chassis, and an array of balls rotatably supported by the chassis. The array of balls define a foot surface. At least one sensor is positioned within the chassis to measure rotation of each of the array of balls about two axes.

### CROSS-REFERENCE TO RELATED APPLICATIONS

This application claims the benefit of U.S. Provisional Patent Application No. 62/684,694, filed Jun. 13, 2018, the contents of which are incorporated herein by reference in their entirety.

### FIELD

The specification relates generally to input systems, and, more particularly, to an input surface system.

### BACKGROUND OF THE DISCLOSURE

In an effort to make computer gaming more immersive, virtual reality (“VR”) gaming devices have been introduced. Amongst the most popular of these VR gaming devices are VR headsets that position a screen in front of the eyes of a user to visually immerse the user in a playing environment. Such VR headsets include an orientation sensing system, either optical, gyroscopic, or accelerometer-based, that determines the orientation and position of the VR headset, transmits the VR headset's orientation to the computing device generating the displayed field-of-view (which may be within the VR headset or may be separate), and then presents updated graphics to the user in response to the detected orientation of the VR headset and the state of the game environment. The VR headsets can additionally include audio speakers and a microphone, in some cases.

While such VR headsets can visually immerse a user in an environment, VR headsets, by themselves, pose challenges. In the case where the VR headset is tethered to a computer, the user must remain within a fixed distance of the computer in order to continue play, making the exploration of large environments (generally done via their own movement) difficult. Further, physical limitations of the space in which a user is situated may, itself, limit the user's ability to explore the VR game environment. For example, where the user is playing the game in a room, the room's walls and other objects can pose limitations to the ability of the user to navigate through the VR game environment.

In order to address such spatial limitations, various solutions have been proposed to enable a user to “move” within a VR game environment. Some of these solutions involve treadmill-like endless belt systems, and even an endless belt oriented along a first axis and having a set of endless belts extending along a second axis that is perpendicular to the first axis. These devices either don't afford natural movement, or are very expensive and require a significant amount of space.

### SUMMARY OF THE DISCLOSURE

In one aspect, there is provided an input surface system, comprising a chassis, an array of balls rotatably supported by the chassis, the array of balls defining a foot surface, and at least one sensor positioned within the chassis to measure rotation of at least one of the array of balls about a first axis and a second axis.

The chassis can include a set of rollers supporting each of the balls, the sets of rollers being pivotally coupled to a frame. Each of at least two of the set of rollers supporting each of the balls can be coupled to an electric motor. Each of the electric motors can be one of the sensors, and generate electrical output corresponding to rotation of the corresponding one of the rollers to which the electric motor is coupled. The input surface system can further include at least one controller coupled to the electric motors, the at least one controller being configured to convert a current generated by each of the electric motors into digital sensor data communicated to a main controller. The at least one controller can selectively control operation of the electric motors based on received instructions.

The input surface system can further include at least one pressure sensor positioned to measure foot pressure on each ball. The input surface system can further include a controller being coupled to the at least one pressure sensor corresponding to each ball to determine a position of a foot atop of the array of balls.

The input surface system can further include a positioning structure defining a position for each of the array of balls in the foot surface. The foot surface can be generally planar.

The chassis can include a set of ball module bases, each of the set of ball module bases rotatably supporting at least one of the array of balls, the set of ball module bases being arrangeable in at least a first configuration so that the array of balls supported by the ball module bases provide the foot surface. The foot surface can be a first foot surface, and a subset of the set of ball module bases can be arrangeable in at least a second configuration so that a corresponding subset of the array of balls provide a second foot surface that differs from the first foot surface in dimension.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 is a perspective view an input surface system having an array of balls in accordance with one embodiment thereof;

FIG. 2 shows the input surface system of FIG. 1 after removal of the array of balls and a portion of a frame thereof;

FIG. 3 is an exploded schematic diagram of a ball module and a section of a positioning structure forming part of the input surface system of FIG. 1;

FIG. 4 is a schematic sectional view of the ball module supporting one of the balls of the array of balls of FIG. 1;

FIG. 5 is a schematic top view of an input surface of the input surface system of FIG. 1;

FIG. 6 is a schematic diagram of an input surface system in accordance with another embodiment having a vibration motor; and

FIG. 7 is a side elevation section view of a portion of an input surface system in accordance with another embodiment thereof.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

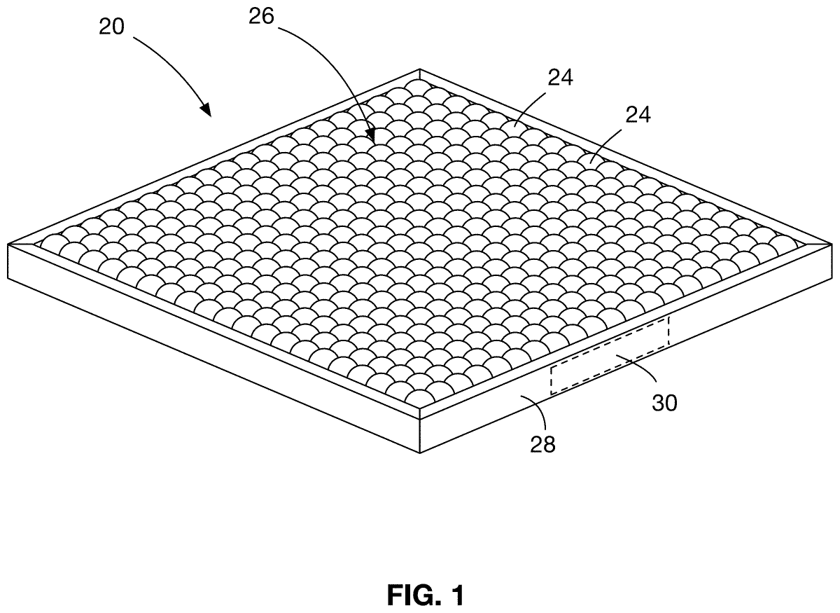

An input surface system 20 in accordance with an embodiment is shown in FIG. 1. The input surface system 20 has an array of balls 24 that define a foot surface 26 that acts as an input surface. The array of balls 24 in this illustrated embodiment is a 20 row by 20 column grid of balls 24 that is approximately three feet wide and three feet deep. The rows and columns are equally spaced. The array of balls 24 is bordered by a frame 28 about each of its four sides.

The size of the balls 24 in the array and the spacing therebetween can be varied. In the illustrated embodiment, the balls 24 have a diameter of approximately 1⅓ inches with a spacing between balls 24 of just under a half inch. In other embodiments, the size of the balls can be, for example, between ¼ inch and two inches, and the spacing can be from ⅛ inch to 1½ inches.

A main controller 30 controls operation of the input surface system 20 is positioned within the frame 28.

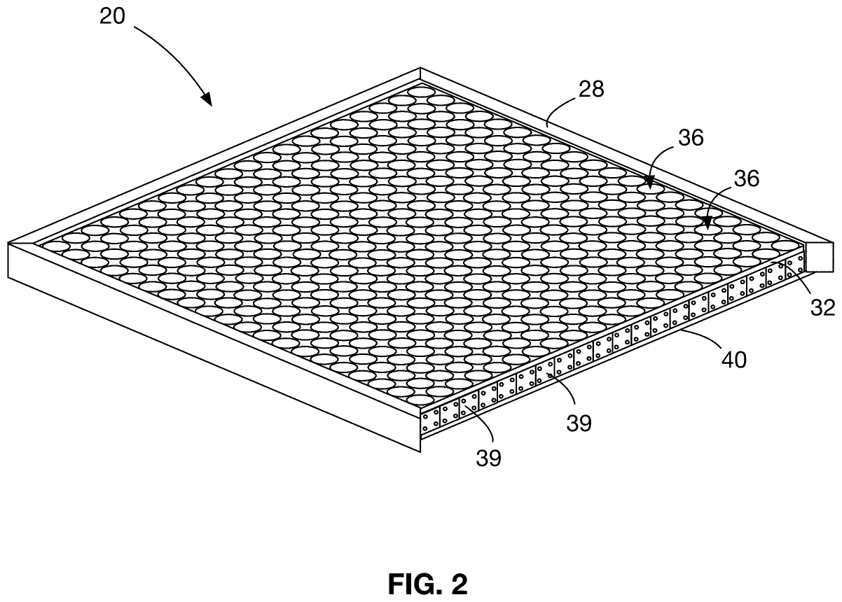

FIG. 2 shows a chassis of the input surface system 20 with the array of balls 24 removed, thereby exposing a positioning structure 32. The positioning structure 32 is a generally planar frame that has a grid of apertures 36 in which the array of balls 24 are positioned. In the currently illustrated embodiment, the positioning structure 32 restricts lateral travel of the balls 24. In some embodiments, the positioning structure can additionally or alternatively restrict upward travel of the balls by having apertures that are dimensioned to have a span smaller than the diameter of the balls.

Positioned below each aperture 36 is a ball module base 39 that rests on a planar base 40. In the illustrated embodiment, the ball module bases 39 abut one another and are held in abutment with one another by the frame 28.

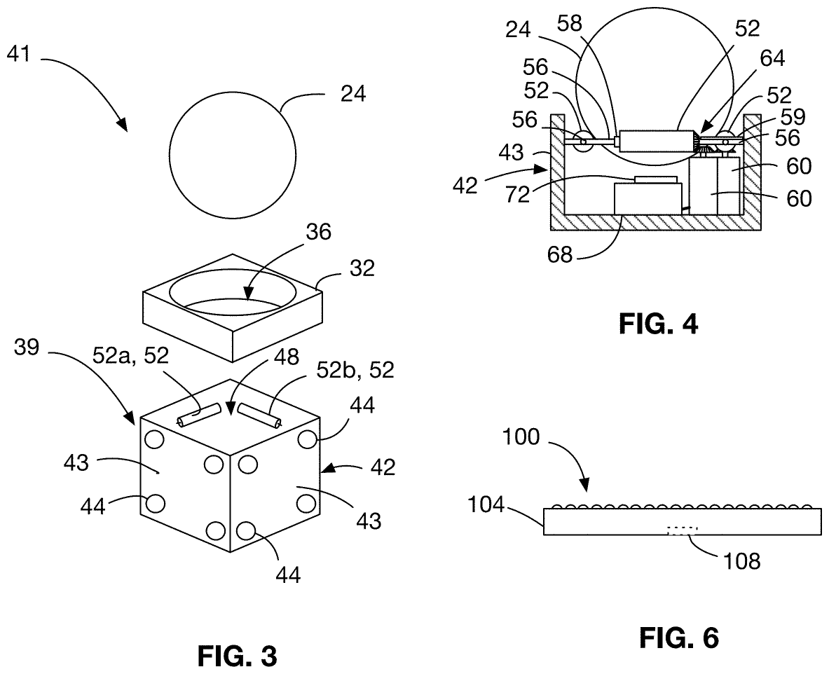

FIG. 3 shows a ball module 41 that is made of one of the ball module bases 39 and a corresponding one of the balls 24. A corresponding portion of the positioning structure 32 is shown interposed between the ball module base 39 and the ball 24. Each of the array of balls 24 is paired with a corresponding ball module base 39 to form a ball module 41. The ball module base 39 has generally cubic housing 42 having a generally square floor from which four sidewalls 43 extend. Each of the sidewalls 43 has a set of contacts 44 that are positioned on an outer surface thereof. The set of contacts 44 are used to power the ball module 41, and enable the ball module 41 to send sensor data to and receive operating instructions from the main controller 30. The contacts 44 can be spring biased, either by the use of a biasing element or via the shape of the contacts 44. When the input surface system 20 is assembled, as shown in FIG. 1, the sets of contacts 44 of one of the ball modules 40 contact corresponding sets of contacts 44 of adjacent ball modules 40. Further, the frame 28 has corresponding contacts that are pushed into contact with the contacts 44 of the peripheral ball modules 40. In this manner, power can be supplied to each of the ball modules 40 in the input surface system 20 via the frame 28, and the main controller 30 within the frame 28 can communicate bidirectionally with each ball module 41.

Now with reference to FIGS. 3 and 4, the top of the ball module 41 is shown being open, defining a ball recess 48 between the four sidewalls 43. Four rollers 52 are rotatably mounted on support bars 56 that span between the sidewalls 43. The support bars 56 are notched to form halved crossing joints where they meet at a right angle, so that the four support bars 56 are horizontally mounted at the same elevation within the ball module 41. The four support bars 56 are arranged so that opposing pairs of the support bars 56 are parallel. The rollers 52 are made from a material that is sufficiently gripped by the ball 28 so that rotation of the ball 28 causes the rollers 52 to rotate appropriately. Conversely, rotation of the rollers 52 cause the ball 28 to rotate. Each of the rollers 52 is generally centrally positioned on the corresponding support bar 56 and is limited from axial movement in one direction along the corresponding support bar 56 by a limiter ring 58 fixed to the support bar 56. Each of the support bars 56 has a flexure sensor in the form of a strain gauge 59 positioned thereon to measure flexure of the support bar 56. One of each pair of rollers 52 on opposing support bars 56 is coupled to an electric motor 60 affixed within the housing 42 of the ball module 41 via a bevel gear arrangement 64.

A mini controller 68 is coupled to the contacts 44, the strain gauges 59, and the motors 60. The mini controller 68 controls operation of the motors 60. Further, the mini controller 68 receives sensor data from the strain gauges 59 that indicate the flexure of the support bars 56, thus acting as a pressure sensor. An LED 72 is positioned to illuminate the ball 28. The ball 28 is made of an at least partially transparent material so that the illumination from the LED 72 illuminates the ball 28 and is visible from above.

When the input surface system 20 is operated, pressure on the ball 28 causes the support bars 56 to flex, and thus cause the strain gauges 59 to provide pressure sensor data the mini controller 68. In this manner, the mini controller 68 can detect pressure on the ball 28.

Further, rotation of the ball 28 causes the rollers 52 to rotate, thus driving the motors 60 to rotate via the bevel gear arrangements 64. The amount of rotation of the rollers 52 depends on the rotation of the ball 28 in a corresponding direction. One pair of the rollers 52 is rotated for rotation of the ball 28 along a first axis, and the other pair of the rollers 52 is rotated for rotation of the ball 28 along a second axis. When the motors 60 are rotated, they generate a current that the mini controller 68 receives and measures to determine how the rate at which the ball 28 is being rotated along each axis. The motors 60 thus act as sensors and the currents they generate act is effectively motion sensor data. The mini controller 68 converts the currents into digital sensor data and communicates it and an identifier of the location of the ball module 41, along with sensor data received from adjacent ball modules 40 to at least one of the adjacent ball modules 40 and the frame 28.

The sensor data received by the main controller 30 from the ball modules 40 via the frame 28 is then analyzed to determine the rate of rotation and depression of each of the balls 28 in the array.

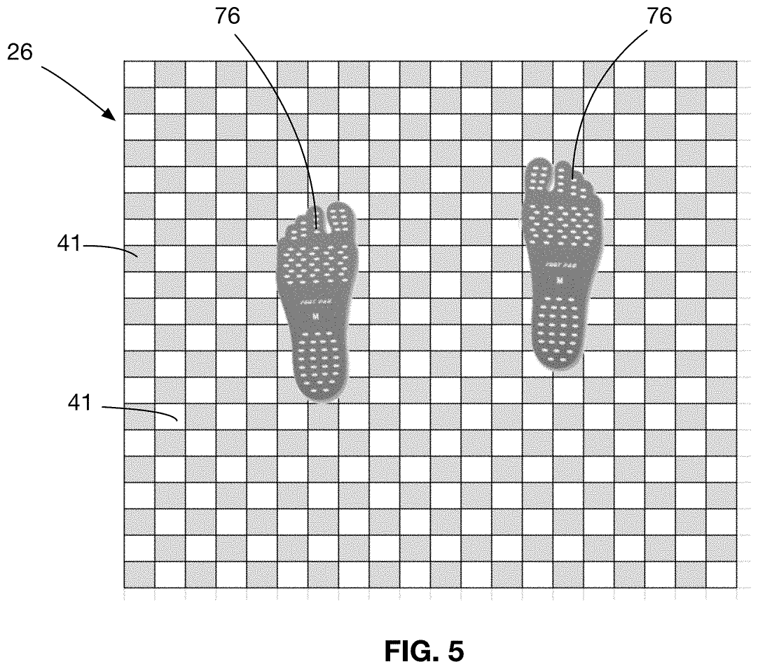

FIG. 5 is a plan view schematic diagram of the foot surface 26 of the input surface system 20 that shows a pair of feet 76 positioned atop of the foot surface 26. The feet 76 make contact with and depress a number of the balls 24 of the ball modules 41.

Referring now to FIGS. 1 to 5, the main controller 30 is configured to determine that a threshold pressure on each of a patch of eight adjacent balls 24 corresponds with the position of a foot 76 thereon. Upon the determination of the position of the foot 76 on particular ball modules 41 of the foot surface 26, rotation of the balls 24 of the particular ball modules 41 in a general direction is deemed to constitute movement of the foot 76 across the foot surface 26.

The main controller 30 may direct one or more of the ball modules 40 to rotate their ball 28 and/or resist rotation of the ball 28. Thus, the mini controller 68 of the ball module 41 can direct each motor 60 to rotate as needed.

The main controller 30 and each mini controller 68 have a processor and storage for at least storing instructions that, when executed by the processor, cause the controller 30 or mini controller 68 to provide the behavior identified above.

The LEDs 72 can be selectively powered by the mini controller 68 when directed by the main controller 30 or in response to the receipt of sensor data to mimic a footprint, indicate where a user should place their feet, etc.

The modularity of the ball modules 41 of the input surface system 100 enables their reconfiguration. While, in the input surface system 20 of FIGS. 1 to 5, the foot surface 26 is made of 400 ball modules 41 in a 20 by 20 array, the ball modules 41 can be reconfigured into a foot surface 26 of other dimensions. For example, in one alternative configuration, a foot surface can be constructed from a subset of the ball modules 41 into an array of ten by ten ball modules 41, providing a less costly and more compact foot surface. In another exemplary alternative configuration, a foot surface can be constructed from a subset of the ball modules 41 into an array of eight by 20 ball modules 41 to sense bi-ped linear movement, such as to simulate straight-line walking. Other foot surface configurations for different applications can be configured using the modular ball modules 41.

FIG. 6 shows an input surface system 100 in accordance with an alternative embodiment. The input surface system 100 has a chassis 104 that houses one or more vibration motors 108 that a main controller can direct to selectively vibrate to improve the experience of the user.

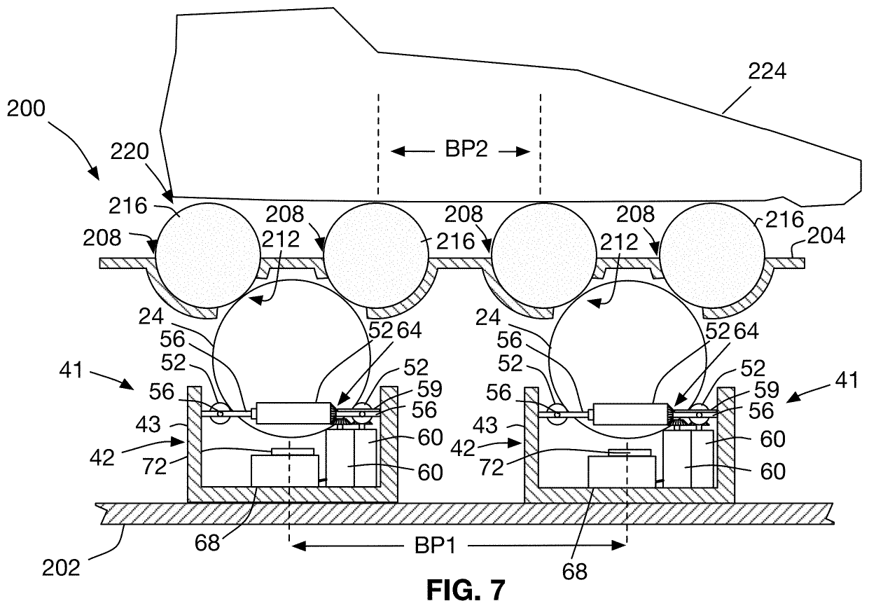

FIG. 7 shows an input surface system 200 in accordance with yet another alternative embodiment. In this embodiment, a frame 202 has a set of ball modules 41 that are spaced apart. Each of the ball modules 41 has a ball module base 39 that supports a ball 24, such as previously described with respect to the embodiment illustrated in FIGS. 1 to 5. The balls 24 are driven via driven rollers 52 of the ball module bases 39. In this embodiment, the balls 24 preferably have a surface that is very tacky. For example, the balls 24 can be made of solid rubber. The ball module bases 39 are spaced apart to accommodate larger motors 60 to drive rotation of the balls 24 with greater force.

Positioned above the ball modules 41 is a ball support tray 204 that has a number of generally evenly spaced recesses 208. Each of the recesses 208 is roughly hemispherical and has a ball contact aperture 212 therein. The ball support tray 204 is preferably made of a rigid material, such as steel, and each of the recesses 208 can have a friction-reducing coating applied along a surface thereof. For example, Teflon™ or another suitable friction-reducing can be applied to the inside surface of the recesses 208.

A surface-providing ball 216 is positioned in each recess 208. The surface-providing balls 216 preferably have a low coefficient of friction so that the surface-providing balls 216 can be rotated within the recesses 208 while being urged towards the recesses 208 with little resistance between the surface-providing balls 216 and the inside surface of the recesses 208. The surface-providing balls 216 collectively provide an input surface 220, and are preferably are compression-resistant to resist deformation while a person is standing thereon.

The surface-providing balls 216 contact the balls 24 through the ball contact apertures 212 at least when a person 224 is standing on the surface-providing balls 216. In a passive mode, when a person 224 slides the sole of their foot or shoe along the surface-providing balls 216, the surface-providing balls 216 are rotated. As there is friction between the balls 24 and the surface-providing balls 216, rotation of the surface-providing balls 216 causes the balls 24 to rotate as well. As previously discussed, rotation of the balls 24 causes the rollers 60 to rotate and be interpreted as rotation of the balls 24. In this manner, movement on the input surface 220 can be sensed and communicated.

In an active mode, the balls 24 can be driven to rotate via operation of the motors 60 to drive the rollers 52 to rotate. As the balls 24 rotate, the surface-providing balls 216 rotate as well through frictional contact with the balls 24 via the ball contact apertures 212 at least when a person 224 is standing thereon.

The input surface system 200 enables larger ball modules to be employed, thereby accommodating larger motors to drive the balls 24. In order to reduce the spacing between contact points along the input surface, a second layer of surface-providing balls is employed that is driven by and can drive the balls 24. While these surface-providing balls are shown as smaller than the balls 24 in FIG. 7, in other embodiments, the surface-providing balls can be equal or larger in size relative to the balls of the ball modules.

Based on the above, it can be said that an array of the balls 24 is rotatably supported by the chassis, and an array of the surface-providing balls 216 is positioned proximate the array of balls 24, the array of surface-providing balls 216 having a second ball-to-ball pitch BP2 that is smaller than a first ball-to-ball pitch BP1 of the array of the balls 24

wherein rotation of either of a first set of the array of first balls and a second set of the array of second balls causes rotation of the other of the first set of the array of first balls and the second set of the array of second balls

The main controller in some embodiments can be external to the input surface system.

Various aspects of the input surface system can be varied. For example, the size of the chassis, the number of balls, their sizes and spacing, the types of sensors, the construction of the chassis, etc.

While, in one of the above-described embodiments, the chassis includes a set of discrete ball modules for replaceability of individual modules and reconfiguration, it can also be constructed in other manners, such as, for example, not using modular elements.

Other types of sensors can be used. For example, each ball can have a pattern of markings that are tracked by an optical sensor within the chassis. Other types of pressure sensors can be employed, such as a biasable structure with a Hall effect sensor. Still alternatively, no pressure sensor may be included in some embodiments.

In other embodiments, the mini controllers of the ball modules can control operation of the motors independently.

While, in the above-described embodiments, each ball module has a single ball, in other embodiments, the ball modules can have two or more balls.

The input surface system can be controlled to simulate the slipperiness, stickiness, etc., of a surface by controlling the rotation of the rollers in response to detected motion and/or pressure.

In still other embodiments, additional elements can be employed to simulate an immersive environment, such as fans, rain and/or mist generators, etc.

Persons skilled in the art will appreciate that there are yet more alternative implementations and modifications possible, and that the above examples are only illustrations of one or more implementations. The scope, therefore, is only to be limited by the claims appended hereto.

1. An input surface system, comprising:
a chassis;
an array of balls rotatably supported by the chassis, the array of balls defining a foot surface; and
at least one sensor positioned within the chassis to measure rotation of at least one of the array of balls about a first axis and a second axis.

2. An input surface system as claimed in claim 1, wherein the chassis includes a set of rollers supporting each of the balls, the sets of rollers being pivotally coupled to a frame.

3. An input surface system as claimed in claim 2, wherein each of at least two of the set of rollers supporting each of the balls is coupled to an electric motor.

4. An input surface system as claimed in claim 3, wherein each of the electric motors is one of the sensors, and generates electrical output corresponding to rotation of the corresponding one of the rollers to which the electric motor is coupled.

5. An input surface system as claimed in claim 4, further comprising at least one controller coupled to the electric motors, the at least one controller being configured to convert a current generated by each of the electric motors into digital sensor data communicated to a main controller.

6. An input surface system as claimed in claim 5, wherein the at least one controller selectively controls operation of the electric motors based on received instructions.

7. An input surface system as claimed in claim 1, further comprising at least one pressure sensor positioned to measure foot pressure on each ball.

8. An input surface system as claimed in claim 7, a controller being coupled to the at least one pressure sensor corresponding to each ball to determine a position of a foot atop of the array of balls.

9. An input surface system as claimed in claim 1, further comprising a positioning structure defining a position for each of the array of balls in the foot surface.

10. An input surface system as claimed in claim 9, wherein the foot surface is generally planar.

11. An input surface system as claimed in claim 1, wherein the chassis includes a set of ball module bases, each of the set of ball module bases rotatably supporting at least one of the array of balls, the set of ball module bases being arrangeable in at least a first configuration so that the array of balls supported by the ball module bases provide the foot surface.

12. An input surface system as claimed in claim 11, wherein the foot surface is a first foot surface, and wherein a subset of the set of ball module bases can be arrangeable in at least a second configuration so that a corresponding subset of the array of balls provide a second foot surface that differs from the first foot surface in dimension.

13. An input surface system, comprising:
a chassis;
an array of first balls rotatably supported by the chassis;
an array of second balls positioned proximate the array of first balls, the array of second balls having a second ball-to-ball pitch that is smaller than a first ball-to-ball pitch of the array of first balls,
wherein rotation of either of a first set of the array of first balls and a second set of the array of second balls causes rotation of the other of the first set of the array of first balls and the second set of the array of second balls.
